(19) United States
(12) Patent Application Publication
(10) Pub. No.: US 2009/0033647 A1
(43) Pub. Date: Feb. 5, 2009

(54) PLASMA DISPLAY AND DRIVING METHOD THEREOF

(76) Inventor: Hyung-Jun An, Suwon-si (KR)

Correspondence Address: CHRISTIE, PARKER & HALE, LLP, PO BOX 7068, PASADENA, CA, 91109-7068, US

(21) Appl. No.: 12/036,073

(22) Filed: Feb. 22, 2008

(30) Foreign Application Priority Data
Aug. 2, 2007 (KR) 10-2007-0077728

(51) Int. Cl. G09G 5/00

(52) U.S. Cl. 345/210

(57) ABSTRACT

In a plasma display device, a plurality of sustain pulses that alternately have a high level voltage and a low level voltage are applied with an opposite phase to that of first and second electrodes that perform a display operation in a sustain period. A width of the last sustain pulse applied to the second electrode in a first time where an accumulated driving time of a plasma display device exceeds a predetermined time is set to be shorter than a width of the last sustain pulse applied to the second electrode in a second time where the accumulated driving time is smaller than the predetermined time.

### CROSS-REFERENCE TO RELATED APPLICATION

This application claims priority to and the benefit of Korean Patent Application No. 10-2007-0077728 filed in the Korean Intellectual Property Office on Aug. 2, 2007, the entire content of which is incorporated herein by reference.

### BACKGROUND OF THE INVENTION

1. Field of the Invention

The present invention relates to a plasma display device and a driving method thereof.

2. Description of the Related Art

Plasma display devices are display devices having a plasma display panel (PDP) that displays text and images using plasma generated by gas discharge.

The plasma display device is driven by dividing a frame into a plurality of subfields each having a predetermined luminance weight value. In each subfield, light emitting cells and non-light emitting cells are selected by address discharge in an address period, and sustain discharges are induced corresponding to the weight value of a corresponding subfield in a sustain period, thereby displaying images. As an accumulated driving time increases, the distance between electrodes becomes shortened by the deterioration of MgO components on a dielectric layer, and discharge is induced in adjacent cells by the collapse of a barrier rib in the plasma display device. In this case, it is difficult to control the discharge. Also, misfiring in which discharge is induced in a non-light emitting cell may occur because a discharge firing voltage becomes reduced.

The above information disclosed in this Background section is only for enhancement of understanding of the background of the invention and therefore it may contain information that does not form the prior art that is already known in this country to a person of ordinary skill in the art.

### SUMMARY OF THE INVENTION

Exemplary embodiments of the present invention provide a plasma display device and a driving method thereof having features of normally inducing discharge even when the accumulated driving time of a plasma display device is increased.

An exemplary embodiment of the present invention provides a method for driving a plasma display device by dividing one frame into a plurality of subfields, where the plasma display device includes a plurality of discharge cells at crossings of a plurality of first electrodes and a plurality of second electrodes extending in a first direction, and a plurality of third electrodes extending in a second direction crossing the first direction. In the driving method, a first driving waveform is applied to the plurality of first electrodes and the plurality of second electrodes in at least one of the plurality of subfields if an accumulated driving time of the plasma display device is less than a reference time, and a second driving waveform that is different from the first driving waveform is applied to the plurality of first electrodes and the plurality of second electrodes in at least one of the plurality of subfields if the accumulated driving time exceeds the reference time. Each of the first and second driving waveforms may include a first waveform that applies at least one first sustain pulse to the plurality of first electrodes and applies at least one second sustain pulse having a phase opposite to that of the first sustain pulse to the plurality of second electrodes in a first sustain period, and a width of the second sustain pulse of the second driving waveform applied last in the first sustain period may be shorter than that of the second sustain pulse of the first driving waveform applied last in the first sustain period.

Another embodiment of the present invention provides a method for driving a plasma display device by dividing one frame into a plurality of subfields, where the plasma display device includes a plurality of first electrodes and a plurality of second electrodes extending in one direction. In the driving method, a first sustain pulse is applied to the plurality of first electrodes at least once, and a second sustain pulse having a phase opposite to that of the first sustain pulse is applied to the plurality of second electrodes at least once, in a first sustain period of at least one of the plurality of subfields. The second sustain pulse that is applied last in the first sustain period when an accumulated driving time of the plasma display device is less than a reference time has a form that is different from the second sustain pulse that is applied last in the first sustain period when the accumulated driving time of the plasma display device exceeds the reference time.

Yet another embodiment of the present invention provides a plasma display device including a plasma display panel, a controller, and a driver. The plasma display panel includes a plurality of discharge cells. The controller divides one frame into a plurality of subfields, and sets a first sustain period in at least one of the plurality of subfields. The driver applies a first sustain pulse, which alternately has a first high level voltage and a first low level voltage, to the plurality of discharge cells at least once in the first sustain period. The controller sets a width of the first sustain pulse that is applied last when an accumulated driving time of the plasma display panel is less than a reference time to be longer than a width of the first sustain pulse that is applied last when the accumulated driving time exceeds the reference time.

### BRIEF DESCRIPTION OF THE DRAWINGS

FIG. 1 is a schematic diagram illustrating a plasma display device according to an exemplary embodiment of the present invention.

FIG. 2 is a flowchart illustrating the operation of a controller shown in FIG. 1.

FIGS. 3, 4 and 5, respectively, are diagrams illustrating normal waveforms of a plasma display device according to first, second and third exemplary embodiments of the present invention.

FIG. 6A is a diagram illustrating a wall charge state after the falling period of a reset period ends according to a normal reset operation.

FIG. 6B is a diagram illustrating a wall charge state after the falling period of a reset period ends by strong discharge.

FIGS. 7, 8 and 9, respectively, are diagrams illustrating modified driving waveforms according to the first, second and third exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, if something is described to “include constituent elements”, it may further include other constituent elements unless it is described that it does not include other constituent elements.

In embodiments of the present invention, a wall charge is a charge formed close to each electrode on the wall of a cell, for example a dielectric layer. Although the wall charges do not actually touch the electrodes, the wall charges will be described as being “formed” or “accumulated” on the electrode. Also, a wall voltage is a potential difference formed at the wall of a cell by wall charges. A weak discharge is a discharge that is weaker than a sustain discharge in a sustain period and an address discharge in an address period.

Hereinafter, a plasma display device and a driving method thereof according to an exemplary embodiment of the present invention will be described with reference to accompanying drawings.

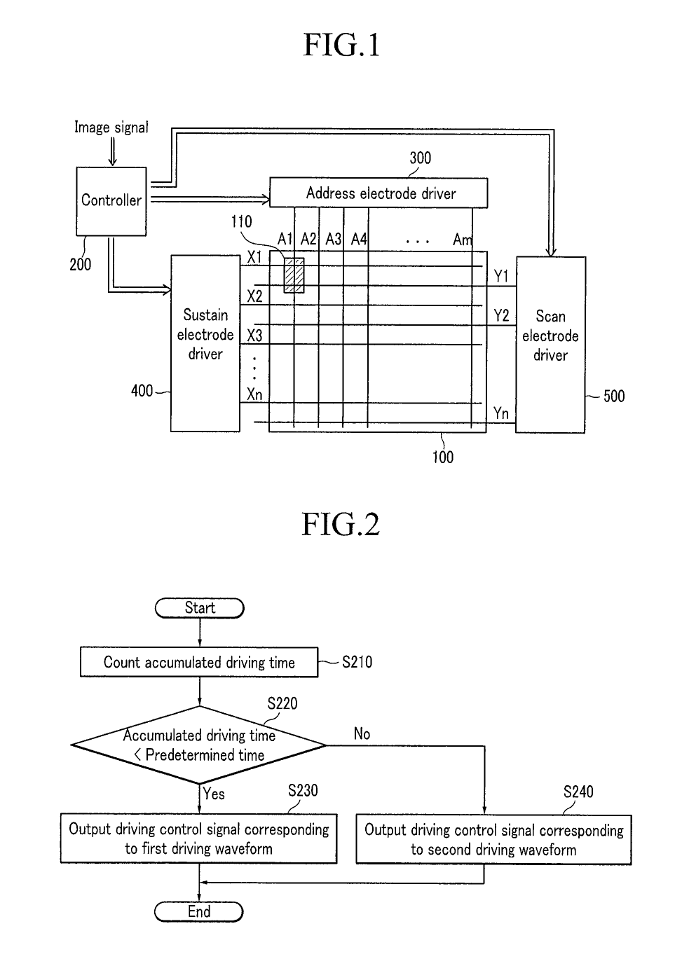

FIG. 1 is a schematic diagram illustrating a plasma display device according to an exemplary embodiment of the present invention, and FIG. 2 is a flowchart illustrating an operation of a controller shown in FIG. 1.

As shown in FIG. 1, a plasma display device according to an exemplary embodiment of the present invention includes a plasma display panel (PDP) 100, a controller 200, an address electrode driver 300, a sustain electrode driver 400, and a scan electrode driver 500.

The plasma display panel (PDP) 100 includes a plurality of address electrodes A1-Am (hereinafter, “A electrodes”) extending in a column direction and a plurality of sustain electrodes X1-Xn (hereinafter, “X electrodes”) and scan electrodes Y1-Yn (hereinafter, “Y electrodes”), which extend in a row direction and form pairs. In general, the X electrodes X1-Xn are respectively formed corresponding to Y electrodes Y1-Yn, and the X electrodes X1-Xn and the Y electrodes Y1-Yn perform a display operation for displaying images in a sustain period. The Y electrodes Y1-Yn and the X electrodes X1-Xn cross A electrodes A1-Am at substantially right angles. A discharge space in the cross region of A electrodes A1-Am and the X and Y electrodes X1-Xn and Y1-Yn forms a discharge cell 110 (hereinafter, “cell”). The above-described structure of the plasma display panel (PDP) 100 is only an exemplary embodiment of the present invention. The embodiments of the present invention can be applied to a panel having another structure to which the driving waveform described below can be applied.

The controller 200 receives a video signal (or image signal) from an external device, outputs the driving control signal to the A electrodes A1-Am, the X electrodes X1-Xn, and the Y electrodes Y1-Yn, and drives the display panel by dividing one frame into a plurality of subfields each having a luminance weight value (e.g., predetermined luminance weight value). The controller 200 according to the present exemplary embodiment outputs different driving control signals to the A electrodes A1-Am, the X electrodes X1-Xn, and the Y electrodes Y1-Yn according to an accumulated driving time of the plasma display device. The controller 200 counts the accumulated driving time of the plasma display device at step S210, as shown in FIG. 2. The controller 200 compares the accumulated driving time of the plasma display device with a reference time (e.g., predetermined time) at step S220. If the accumulated driving time is smaller than the reference time, the controller 200 outputs a control signal having the first driving waveform to the A electrodes A1-Am, the X electrodes X1-Xn, and the Y electrodes Y1-Yn at step S230. On the contrary, if the accumulated driving time is greater than the reference time, at step 240, the controller 200 outputs a control signal having the second driving waveform, which is different from the first driving waveform, to the A electrodes A1-Am, the X electrodes X1-Xn, and the Y electrodes Y1-Yn. Hereinafter, the first driving waveform is defined as a “normal driving waveform” and the second driving waveform is defined as a “modified driving waveform”.

The address electrode driver 300 applies a driving voltage to the A electrodes A1-Am according to the driving control signal from the controller 200.

The sustain electrode driver 400 applies a driving voltage to the X electrodes X1-Xn according to the driving control signal from the controller 200.

The scan electrode driver 500 applies a driving voltage to the Y electrodes Yl-Yn according to a driving control signal from the controller 200.

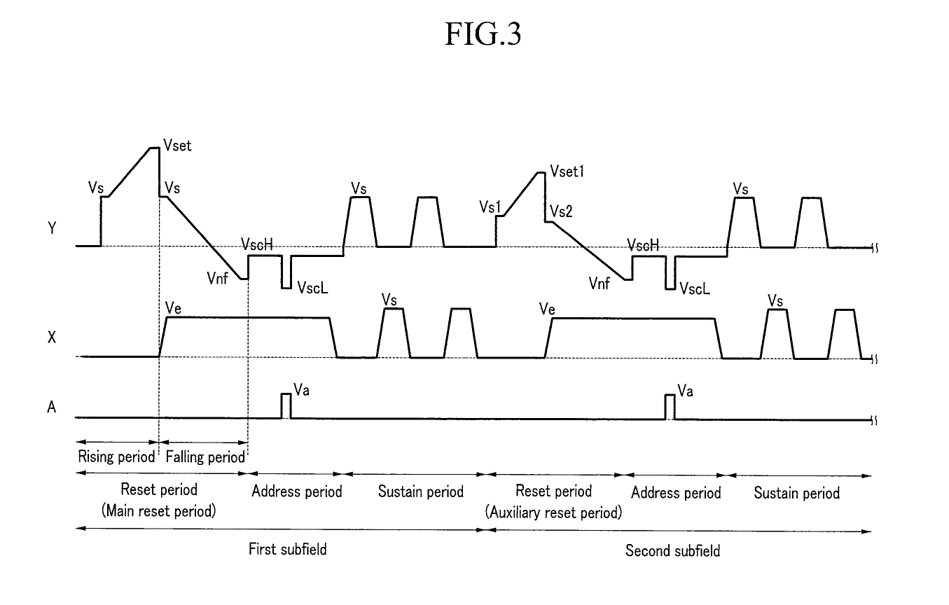

Hereinafter, the normal driving waveform applied to the A electrodes A1-Am, the X electrodes X1-Xn, and the Y electrodes Y1-Yn will be described in detail with reference to FIGS. 3-5, FIG. 6A, and FIG. 6B.

FIG. 3 is a diagram illustrating a normal driving waveform of a plasma display device according to a first exemplary embodiment of the present invention. In FIG. 3, the normal driving waveform will be described with a cell formed by an A electrode, an X electrode, and a Y electrode as a reference.

As shown in FIG. 3, a subfield includes a reset period, an address period, and a sustain period. In general, the reset period of one subfield among a plurality of subfields may be formed of a main reset period, and the reset periods of the other subfields may be formed of auxiliary reset periods. Also, a plurality of subfields may be formed of main reset periods or auxiliary reset periods only. The main reset period induces a reset discharge at all cells, and the auxiliary reset period induces the reset discharge only at light emitting cells that induced sustain discharge in a previous subfield to reduce background luminance. In FIG. 3, the reset period of the first subfield is described as the main reset period, and the reset period of the second subfield is described as the auxiliary reset period.

In the main reset period of the first subfield, the address electrode driver 300 and the sustain electrode driver 400 bias each of the A electrodes and the X electrodes using a reference voltage, for example 0V, and the scan electrode driver 500 gradually increases the voltage of the Y electrode from a Vs voltage to a Vset voltage as shown in FIG. 3. In FIG. 3, the voltage of the Y electrode increases with a ramp pattern. Then, a weak discharge is induced between the Y electrode and the X electrode and between the Y electrode and the A electrode while the voltage of the Y electrode is increasing, and negative (−) wall charges are formed at the Y electrode and positive (+) wall charges are formed at the X and A electrodes. At this time, the Vset voltage may be set to be larger than a discharge firing voltage between the X electrode and the Y electrode in order to induce discharge at all cells.

Then, in the main reset period of the first subfield, the sustain electrode driver 400 biases the X electrode with a Ve voltage, and the scan electrode driver 500 gradually decreases the voltage of the Y electrode from a Vs voltage to a Vnf voltage during a falling period. In FIG. 3, the voltage of the Y electrode decreases with a ramp pattern. Then, weak discharge is induced between the Y electrode and the X electrode and between the Y electrode and the A electrode while the voltage of the Y electrode is decreasing, and the negative (−) wall charges formed at the Y electrode and the positive (+) wall charges formed at the X electrode and the A electrode are erased. In general, a Ve voltage and a Vnf voltage are set to make the wall voltage between the Y electrode and the X electrode close to 0V for cells not selected at the address period to not induce sustain discharge at the sustain period. That is, the (Ve-Vnf) voltage is set to be about a discharge firing voltage between the Y electrode and the X electrode.

Then, in the address period of the first subfield, the sustain electrode driver 400 sustains the voltage of the X electrode, and the scan electrode driver 500 and the address electrode driver 300 apply a scan pulse having a VscL voltage and an address pulse having a Va voltage to the Y electrode and the A electrode. The unselected Y electrode is biased by a VscH voltage that is higher than the VscL voltage, and a reference voltage is applied to the A electrode of a non-light emitting cell. Here, the VscL voltage may be a voltage that is identical to or lower than the Vnf voltage.

The scan electrode driver 500 and the address electrode driver 300 apply a scan pulse to the first row of the Y electrodes Y1 in FIG. 1 and simultaneously (or concurrently) apply an address pulse to A electrodes in light emitting cells among the first row. Then, address discharge is induced between the first row Y electrodes and the A electrodes with the address pulse applied. The address discharge induces positive (+) wall charges at the Y electrode and negative (−) wall charges at the A and X electrodes. Subsequently, the scan electrode driver 500 and the address electrode driver 300 apply the scan pulse to the second row of Y electrodes Y2 in FIG. 1 and apply the address pulse to A electrodes in light emitting cells in the second row. Then, address discharge is induced at a cell formed by the A electrode with the address pulse applied and the second row of the Y electrodes, thereby forming wall charges in the cell. Likewise, the scan electrode driver 500 and address electrode driver 300 sequentially apply the scan pulse to remaining rows of Y electrodes and apply the address pulse to A electrodes in light emitting cells, thereby forming wall charges.

In the sustain period of the first subfield, the scan electrode driver 500 applies sustain pulses that alternately have a high level voltage, for example Vs in FIG. 3, and a low level voltage, for example 0V in FIG. 3, to the Y electrode as many times as a number corresponding to the weight value of a corresponding subfield. The sustain electrode driver 400 applies the sustain pulse to the X electrode, which has a phase opposite that of the sustain pulse applied to the Y electrode. That is, 0V is applied to the X electrode when a Vs voltage is applied to the Y electrode, and the Vs voltage is applied to the X electrode when 0V is applied to the Y electrode. As described above, the voltage difference between the Y electrode and the X electrode alternately has a Vs voltage and a −Vs voltage. Accordingly, the sustain discharges are repeatedly induced at light emitting cells as many times as the number corresponding to the weight value of the corresponding subfield (e.g., the predetermined number).

Then, in the auxiliary reset period of the second subfield, the sustain electrode driver 400 applies a reference voltage to the X electrode, and the scan electrode driver 500 gradually increases the voltage of the Y electrode from a Vs1 voltage to a Vset1 voltage during a rising period. If the sum of a wall voltage between the X electrode and the Y electrode in a light emitting cell and a voltage applied to the Y electrode is greater than the discharge firing voltage between the X electrode and the Y electrode, weak discharge is induced between the Y electrode and the X electrode in the light emitting cell. If the sum of a wall voltage between the Y electrode and the A electrode and a voltage applied to the Y electrode is greater than the discharge firing voltage between the A electrode and the Y electrode, weak discharge is also induced between the Y electrode and the A electrode in a light emitting cell. As a result, negative (−) wall charges are formed at the Y electrode of the light emitting cell, and positive (+) wall charges are formed at the X electrode and the A electrode in the light emitting cell. Since the reset period of the second subfield is the auxiliary reset period, a Vset1 voltage is set to satisfy Equation 1 if sustain discharge was not induced in the previous first subfield.

|Vset1−0 V|<|Ve−Vnf| Equation 1

Since the reset discharge is induced in all cells if the voltage of the Y electrode increases to the Vset voltage, the Vset1 voltage may be set to be lower than the Vset voltage.

Then, in the auxiliary reset period of the first subfield, the scan electrode driver 500 gradually decreases the Y electrode voltage from a Vs2 voltage to a Vnf voltage in a falling period after the sustain electrode driver 400 and the address electrode driver 300 respectively apply a Ve voltage and a reference voltage to the X electrode and the A electrode. If the voltage of the Y electrode decreases from a Vset1 voltage to a Vnf voltage, the reset period may extend. Therefore, the voltage may decrease from a Vs2 voltage that does not induce discharge. Then, weak discharge is induced between the Y electrode and the X electrode in the light emitting cell and the Y electrode and the A electrode while the voltage of the Y electrode is decreasing. Further, negative (−) wall charges formed at the Y electrode of the light emitting cell and positive (+) wall charges formed at the X and A electrodes in the light emitting cell are erased.

Then, light emitting cells and non-light emitting cells are selected through address discharge during an address period, and sustain discharge is performed for a light emitting cell during a sustain period in the second subfield identically to the first subfield.

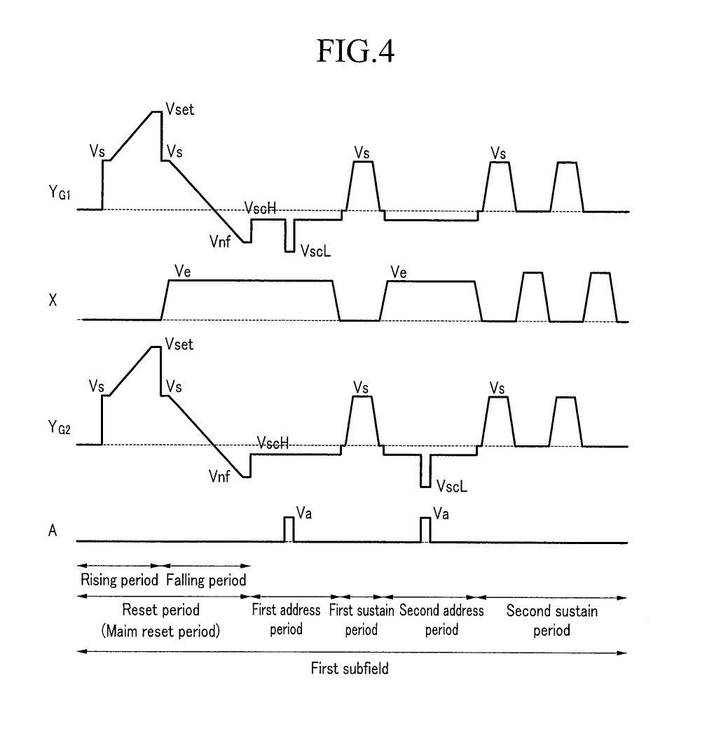

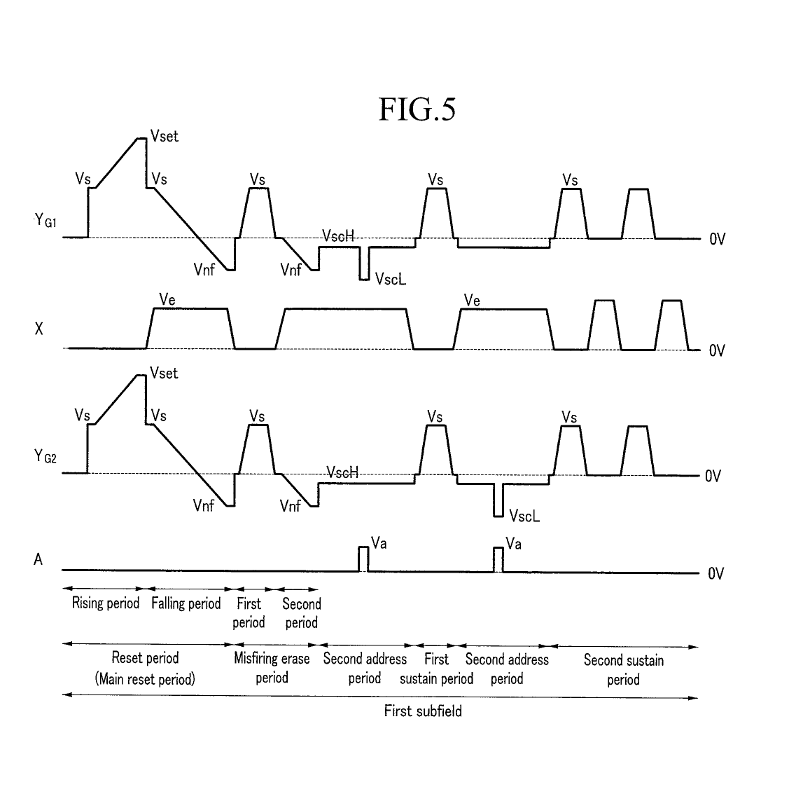

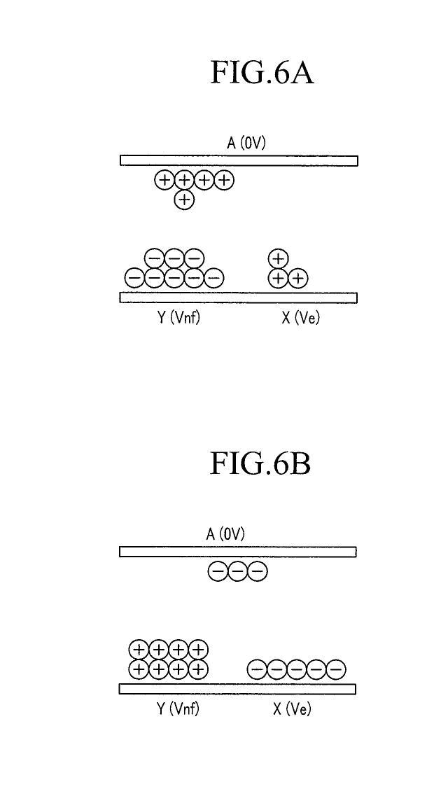

FIG. 4 and FIG. 5 are diagrams respectively illustrating normal driving waveforms of a plasma display device according to second and third exemplary embodiments of the present invention, FIG. 6A is a diagram illustrating a wall charge state after the falling period of a reset period ends according to a normal reset operation, and FIG. 6B is a diagram illustrating a wall charge state after the falling period of a reset period ends by strong discharge. In FIG. 4, the normal driving waveforms in the first subfield are illustrated, and the normal driving waveform will be described with cells formed by one A electrode, one X electrode, and two Y electrodes as reference.

As shown in FIG. 4, the Y electrodes Y1-Yn in FIG. 1 are divided into a plurality of groups. In FIG. 4, the Y electrodes Y1-Yn of FIG. 1 are divided in two groups. The Y electrodes Y1-Yn of FIG. 1 may be divided into Y electrodes disposed at the upper part of the PDP 100 and Y electrodes disposed at the lower part of the PDP 100. Also, the Y electrodes Y1-Yn of FIG. 1 may be divided into odd-numbered Y electrodes and even-numbered Y electrodes. Furthermore, Y electrodes separated by a regular interval may be set as one group, and other electrodes may be set as another group. If necessary, the Y electrodes Y1-Yn of FIG. 1 may be divided into a plurality of groups through irregular methods.

In the first address period, light emitting cells are selected from cells in the first group, which are formed of the Y electrodes Y_{G1} in the first group and A electrodes. In the second address period, light emitting cells are selected from cells formed of Y electrodes (Y_{G2}) in the second group and the A electrodes. The light emitting cells in the first group, selected for the first sustain period between the first address period and the second address period, are sustain-discharged, and the light emitting cells in the first and second groups are sustain-discharged in the second sustain period that follows the second address period.

In the first address period, the sustain electrode driver 400 applies a Ve voltage to an X electrode, and the scan electrode driver 500 and the address electrode driver 300 apply a scan pulse and an address pulse having a VscL voltage to the first group of the Y electrodes Y_{G1} and the A electrode in order to select the light emitting cells, as shown in FIG. 4. At this time, a method of applying the scan pulse to the Y electrodes in the first group is identical to that shown in FIG. 3.

In the first sustain period, the scan electrode driver 500 applies the sustain pulse having a Vs voltage to the Y electrodes Y_{G1} and Y_{G2}, and the sustain electrode driver 400 applies 0V to the X electrode. Then, sustain discharge is induced only at cells that induce address discharge in the first address period, that is, the light emitting cells of the first group. As a result of the sustain discharge, negative (−) wall charges are formed at the Y electrodes of the light emitting cells in the first group and positive (+) wall charges are formed at the X electrodes of the light emitting cells in the first group. In FIG. 4, the driving waveform is set to induce a sustain discharge one time in the first sustain period.

In the second address period, the sustain electrode driver 400 applies a Ve voltage to an X electrode, and the scan electrode driver 500 and the address electrode driver 300 apply a scan pulse and an address pulse of a VscL voltage to the Y electrode Y_{G2} and the A electrode in the second group in order to select light emitting cells. A method of applying the scan pulse to the Y electrodes in the second group is also identical to that shown in FIG. 3. At this time, sustain discharge is induced again at the light emitting cells in the first group by the Ve voltage applied to the X electrode and the wall charges formed at the Y electrode Y_{G1} and the X electrode in the first group because the VscH voltage is lowered. As a result, positive (+) wall charges are formed at the Y electrode Y_{G1} in the first group, and negative (−) wall charges are formed at the X electrode.

Then, in the second sustain period, the scan electrode driver 500 applies a sustain pulse to the Y electrodes Y_{G1} and Y_{G2} as many times as a number corresponding to the weight value of a corresponding subfield, and the sustain electrode driver 400 applies a sustain pulse having a phase that is opposite to that of the sustain pulse applied to the Y electrode to an X electrode. Then, the voltage difference between the Y electrodes Y_{G1} and Y_{G2} and the X electrode alternately has a Vs voltage and a −Vs voltage. Accordingly, sustain discharge is repeatedly induced at the light emitting cell as many times as the number corresponding to the weight value of the corresponding subfield (e.g., the predetermined number).

Since sustain discharges are induced at the light emitting cells of the first group in the first sustain period and the second address period, the number of times of inducing the sustain discharge in the light emitting cell of the first group is greater than the number of times of inducing sustain discharge at the light emitting cell of the second group. Therefore, if the first address period is performed first in the first subfield, the second address period is performed first in the second subfield. If the first address period and the second address period alternate in a plurality of subfields during one frame as described above, the number of times of inducing sustain discharges in the light emitting cells in the first group and the second group in one frame may become identical. As another method, sustain discharge may be not induced at the light emitting cells of the first group and may be induced at the light emitting cells of the second group in a period (e.g., a predetermined period) of the second sustain period. Then, the number of times of inducing sustain discharge in the first and second groups become identical in the first subfield.

Since the light emitting cells of the first and second groups according to the second exemplary embodiment of the present invention induce sustain discharges faster than that of the first exemplary embodiment, the wall charges of the light emitting cell of the first and second groups are erased less. Therefore, sustain discharges can be induced better in the light emitting cells of the first and second groups.

As shown in FIG. 5, a misfiring erase period is included between the reset period and the first address period according to the third exemplary embodiment of the present invention. The misfiring erase period substantially prevents misfiring from being generated even though strong discharge is induced in an unstable reset operation. In the misfiring erase period of the first period, the address electrode driver 300 and the sustain electrode driver 400 apply 0V to each of the A electrode and the X electrode, and the scan electrode driver 500 applies a Vs voltage to the Y electrode. Then, in the misfiring erase period of the second period, the sustain electrode driver 400 applies a Ve voltage to the X electrode, and the scan electrode driver 500 gradually decreases the voltage of the Y electrode from 0V that is lower than a Vs voltage to a Vnf voltage. By doing so, discharge can be induced in a sustain period without inducing address discharge even though strong discharge is induced in the reset period due to the unstable reset operation.

In more detail, if weak discharge is normally formed at the falling period of the reset period, each of the electrodes has a wall charge state shown in FIG. 6A. Since discharge is not induced even though a Vs voltage is applied to a Y electrode in the first period of the misfiring erase period under this condition, the wall charge state becomes substantially identical to the wall charge state after the falling period. If weak discharge is induced between the Y electrode and the X electrode and between the X electrode and the A electrode while the voltage of the Y electrode is decreasing in the second period, negative (−) wall charges formed at the Y electrode and positive (+) wall charges formed at the X electrode and the A electrode are substantially erased.

On the contrary, if strong discharge is induced by an unstable reset operation in the falling period of a reset period, each of the electrodes has a wall charge state shown in FIG. 6B. If a Vs voltage is applied to a Y electrode in the first period of the misfiring erase period, discharge is induced, thereby forming negative (−) wall charges at the Y electrode and forming positive (+) wall charges at the X electrode. Then, if weak discharge is induced between the Y electrode and the X electrode and the Y electrode and the A electrode while the voltage of the Y electrode is decreasing in the second period of the misfiring erase period, the negative (−) wall charges formed at the Y electrode and the positive (+) wall charges formed at the X electrode and the A electrode are substantially erased. Therefore, misfiring is not generated even though strong discharge is generated in the falling period of a reset period.

Although the misfiring erase period is described in FIG. 5 to be applied to the driving waveform of FIG. 4, the misfiring erase period can be applied to the driving waveform of FIG. 3, and to any other driving waveforms.

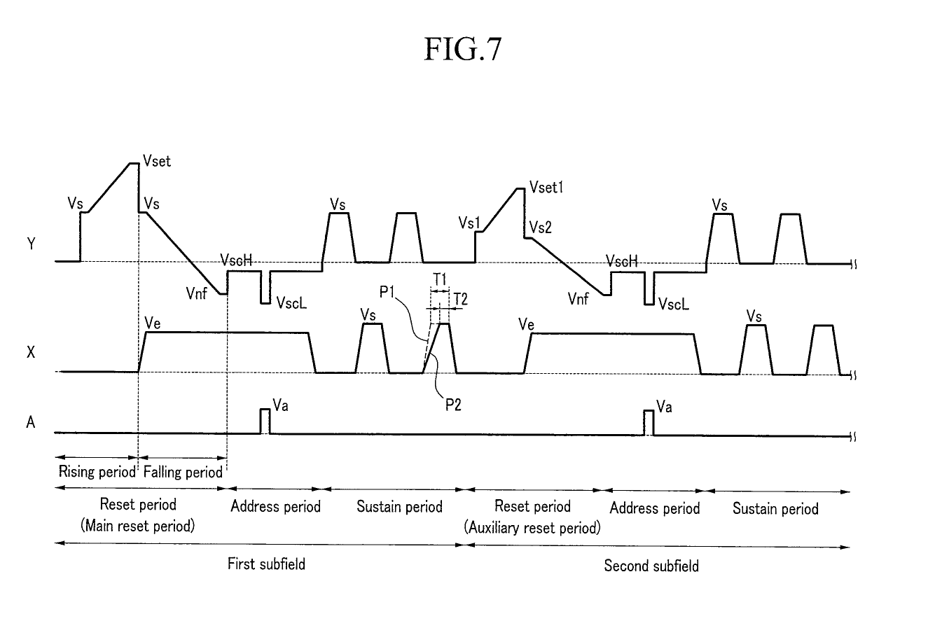

Hereinafter, the modified driving waveform of a plasma display device when the accumulated driving time of the plasma display device exceeds a reference time (e.g., predetermined time) will be described with reference to FIGS. 7, 8 and 9.

FIGS. 7, 8 and 9, respectively, are diagrams illustrating modified driving waveforms according to the first, second and third exemplary embodiments of the present invention. The driving waveforms in FIGS. 7, 8 and 9 respectively correspond to those shown in FIGS. 3, 4 and 5.

As shown in FIG. 7, in the modified driving waveform according to the first exemplary embodiment of the present invention, a period T2 in which a sustain pulse P2 lastly applied to an X electrode has a high level voltage in a sustain period is shorter than a period T1 in which a sustain pulse P1 lastly applied to a sustain period of a normal driving waveform has a high level voltage. Then, a period in which a voltage difference between the X electrode and the Y electrode and a voltage difference between the X electrode and an A electrode are maintained at the voltage of Vs gets shorter. Accordingly, charges occurred through a last sustain discharge and formed in the cell may be less. Therefore, misfiring may not be generated even though the discharge firing voltage becomes lowered when an accumulated driving time of the plasma display device exceeds a predetermined time.

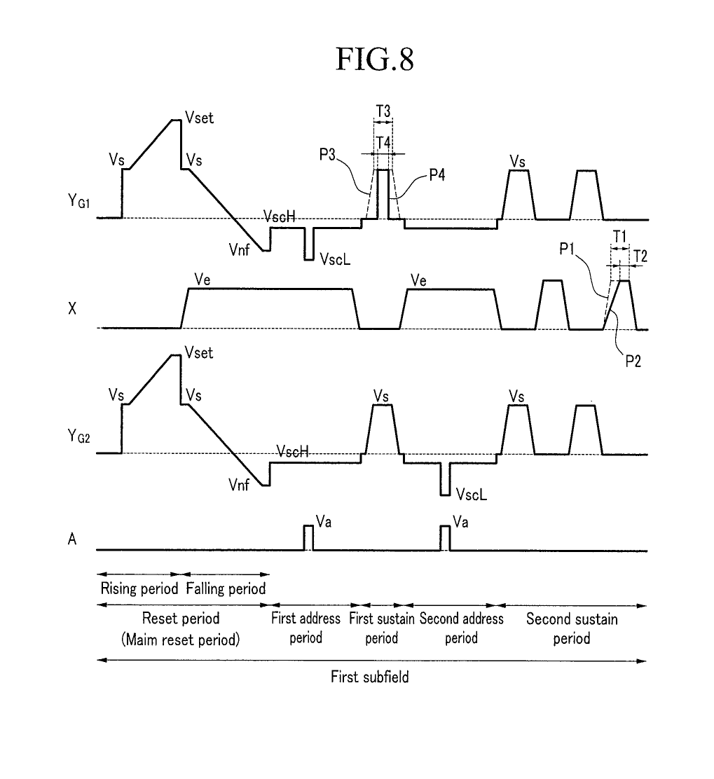

As shown in FIG. 8, in the modified driving waveform according to the second exemplary embodiment of the present invention, a period T2 in which a sustain pulse P2 lastly applied to the X electrode in the second sustain period has a high level voltage is shorter than a period T1 in which a sustain pulse P1 lastly applied to the second sustain period of a normal driving waveform has a high level voltage. Also, the width T4 of a sustain pulse P4 applied to a Y electrode in the first sustain period is shorter than the width T3 of a sustain pulse P3 applied to a Y electrode in the first sustain period of a normal driving waveform.

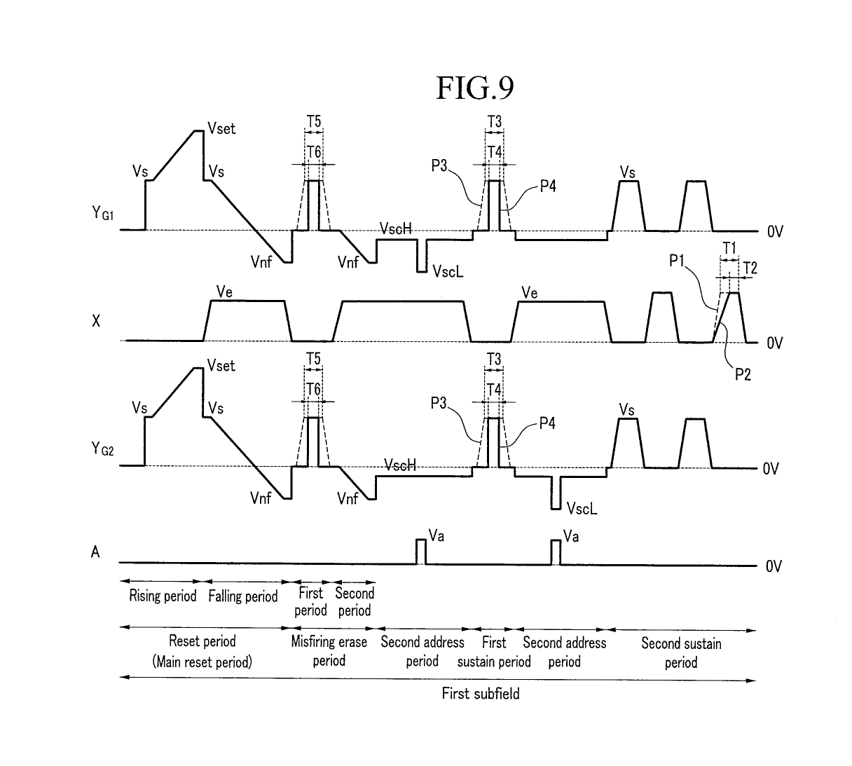

In the modified driving waveform according to the third exemplary embodiment of the present invention as shown in FIG. 9, a period T6 for applying a Vs voltage to a Y electrode in a misfiring erase period is shorter than a period T5 for applying a Vs voltage to a Y electrode in a misfiring erase period of a normal driving waveform.

Since the modified driving waveforms according to the second and third embodiments of the present invention form less wall charges at cells than a normal driving waveform, misfiring may not be generated even though a discharge firing voltage becomes lower because the accumulated driving time of a plasma display device exceeds the reference time (e.g., predetermined time).

When the accumulated driving time of a plasma display device exceeds the reference time, the embodiments of the present invention can be applied to other types of normal driving waveforms and other types of modified driving waveforms that form less wall charges as well as the normal driving waveforms according to the first to third exemplary embodiments of the present invention and the modified driving waveforms according to the first to third exemplary embodiments of the present invention.

Even though the misfiring erase period is applied to the driving waveform of FIG. 4 in FIG. 5, the misfiring erase period can be applied to the driving waveform in FIG. 3 and any other suitable driving waveforms.

According to an exemplary embodiment of the present invention, discharge can be efficiently controlled by modifying a driving waveform when the accumulated driving time of a plasma display panel (PDP) exceeds a predetermined time. Also, misfiring can be prevented.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims and their equivalents.

What is claimed is:

1. A method for driving a plasma display device by dividing one frame into a plurality of subfields, the plasma display device comprising a plurality of discharge cells at crossings of a plurality of first electrodes and a plurality of second electrodes extending in a first direction, and a plurality of third electrodes extending in a second direction crossing the first direction, the method comprising:
applying a first driving waveform to the plurality of first electrodes and the plurality of second electrodes in at least one of the plurality of subfields if an accumulated driving time of the plasma display device is less than a reference time; and
applying a second driving waveform that is different from the first driving waveform to the plurality of first electrodes and the plurality of second electrodes in at least one of the plurality of subfields if the accumulated driving time exceeds the reference time,
wherein each of the first and second driving waveforms includes a first waveform for applying at least one first sustain pulse to the plurality of first electrodes and at least one second sustain pulse having a phase that is opposite to that of the first sustain pulse to the plurality of second electrodes in a first sustain period, and
a width of the second sustain pulse of the second driving waveform applied last in the first sustain period is shorter than that of the second sustain pulse of the first driving waveform applied last in the first sustain period.

2. The method of claim 1, wherein the second sustain pulse that is applied last is applied in at least one of the plurality of subfields so as to induce a last sustain discharge.

3. The method of claim 1, wherein the plurality of first electrodes are divided into a plurality of groups, and
each of the first and second driving waveforms further comprises
a plurality of second waveforms for selecting light emitting cells from the discharge cells corresponding to each group in an address period of each group, and
a third waveform for applying a first voltage to the plurality of first electrodes and a second voltage that is lower than the first voltage to the plurality of second electrodes in a second sustain period between address periods of two adjacent groups among address periods in each group, and
a period in which the second driving waveform has the first voltage is shorter than a period in which the first driving waveform has the first voltage.

4. The method of claim 3, wherein the first waveform is after a last address period among the address periods of each group.

5. The method of claim 3, wherein each of the first and second driving waveforms comprises:
a fourth waveform for inducing a reset discharge in at least one discharge cell among the plurality of discharge cells in a reset period; and
a fifth waveform for applying a third voltage and a fourth voltage to the plurality of first electrodes and the plurality of second electrodes during a first period, for applying a fifth voltage that is greater than the fourth voltage to the plurality of second electrodes during a second period, and for gradually reducing the voltage of the plurality of first electrodes to a sixth voltage in a misfiring erase period following the reset period,
wherein the first period of the second driving waveform is shorter than the first period of the first driving waveform.

6. The method of claim 5, wherein the fourth waveform gradually decreases voltages of the plurality of first electrodes from an eighth voltage to a ninth voltage after a seventh voltage is applied to the plurality of second electrodes.

7. The method of claim 6, wherein the fourth waveform further comprises a seventh waveform that gradually increases a voltage of the plurality of first electrodes from an eleventh voltage to a twelfth voltage after a tenth voltage that is lower than the seventh voltage is applied to the plurality of second electrodes.

8. The method of claim 1, wherein each of the first and second driving waveforms comprises:
a fourth waveform for inducing a reset discharge in at least one discharge cell among the plurality of discharge cells in a reset period; and
a fifth waveform for applying a third voltage and a fourth voltage to the plurality of first electrodes and the plurality of second electrodes during a first period, for applying a fifth voltage that is greater than the fourth voltage to the plurality of second electrodes during a second period, and for gradually reducing a voltage of the plurality of first electrodes to a sixth voltage in a misfiring erase period following the reset period,
wherein the first period of the second driving waveform is shorter than the first period of the first driving waveform.

9. The method of claim 8, wherein the fourth waveform gradually decreases a voltage of the plurality of first electrodes from an eighth voltage to a ninth voltage after a seventh voltage is applied to the plurality of second electrodes.

10. The method of claim 9, wherein the fourth waveform further comprises a seventh waveform that gradually increases a voltage of the plurality of first electrodes from an eleventh voltage to a twelfth voltage after a tenth voltage that is lower than the seventh voltage is applied to the plurality of second electrodes.

11. A method for driving a plasma display device by dividing one frame into a plurality of subfields, the plasma display device comprising a plurality of first electrodes and a plurality of second electrodes extending in one direction, the method comprising:
in a first sustain period of at least one of the plurality of subfields,
applying a first sustain pulse to the plurality of first electrodes at least once; and
applying a second sustain pulse having a phase opposite to that of the first sustain pulse to the plurality of second electrodes at least once,
wherein the second sustain pulse that is applied last in the first sustain period when an accumulated driving time of the plasma display device is less than a reference time has a waveform that is different from that of the second sustain pulse that is applied last in the first sustain period when the accumulated driving time of the plasma display device exceeds the reference time.

12. The method of claim 11, wherein the first and second sustain pulses alternately have a first high level voltage and a first low level voltage, and
a period in which the second sustain pulse that is applied last has the first high level voltage when the accumulated driving time exceeds the reference time is shorter than a period in which the second sustain pulse that is applied last has the first high level voltage when the accumulated driving time is less than the reference time.

13. The method of claim 12, further comprising:
in at least one subfield,
dividing the plurality of first electrodes into a first group and a second group;
applying a scan pulse to the first electrode in the first group during a first address period;
applying the scan pulse to the first electrode in the second group during a second address period; and
applying a second high level voltage to the plurality of first electrodes during a second sustain period between a first address period and a second address period,
wherein a period for applying the second high level voltage to the plurality of first electrodes when the accumulated driving time exceeds the reference time is shorter than a period for applying the second high level voltage to the plurality of first electrodes when the accumulated driving time is less than the reference time.

14. The method of claim 12, further comprising:
in at least one of the subfields,
gradually decreasing a voltage of the plurality of first electrodes from a second voltage to a third voltage during a reset period after a first voltage is applied to the plurality of second electrodes; and
gradually decreasing a voltage of the plurality of first electrodes to a third voltage with the first voltage applied to the plurality of second electrodes after a fourth voltage that is lower than the first voltage and a fifth voltage that is lower than the fourth voltage are applied to the plurality of first electrodes and the plurality of second electrodes during the reset period and a following misfiring erase period,
wherein a period for applying a fifth voltage to the plurality of first electrodes when the accumulated driving time exceeds the reference time is shorter than a period for applying a fifth voltage to the plurality of first electrodes when the accumulated driving time is less than the reference time.

15. A plasma display device comprising:
a plasma display panel (PDP) having a plurality of discharge cells;
a controller for dividing one frame into a plurality of subfields, and setting a first sustain period in at least one of the plurality of subfields; and
a driver for applying a first sustain pulse, which alternately has a first high level voltage and a first low level voltage, to the plurality of discharge cells at least once in the first sustain period,
wherein the controller is configured to set a width of the first sustain pulse that is applied last when an accumulated driving time of the plasma display panel is less than a reference time to be longer than a width of the first sustain pulse that is applied last when the accumulated driving time exceeds the reference time.

16. The plasma display device of claim 15, wherein:
the controller is configured to divide the plurality of discharge cells into a plurality of groups, to set a plurality of address periods corresponding to each of the plurality of groups in at least one of the subfields, and to set a second sustain period between two adjacent address periods among the plurality of address periods;
the driver is configured to apply a second sustain pulse, which alternately has a second high level voltage and a second low level voltage, to the plurality of discharge cells at least one time in the second sustain period; and
the controller is configured to set a width of the second sustain pulse when the accumulated driving time is less than the reference time to be longer than a width of the second sustain pulse when the accumulated driving time exceeds the reference time.

17. The plasma display device of claim 16, wherein the controller is configured to set the first sustain period after a last address period among the plurality of address periods.

18. The plasma display device of claim 15, wherein:
the plurality of discharge cells are defined by the first electrodes and the second electrodes, which extend in a first direction;
the controller is further configured to set a reset period, an address period, and a misfiring erase period between the reset period and the address period;
the driver is configured to gradually decrease a voltage of the first electrodes with a third voltage that is higher than the second voltage applied to the second electrodes after a first voltage and the second voltage are applied to the first electrodes and the second electrodes in the misfiring erase period; and
the controller is configured to set a period for applying the first voltage to the first electrodes when the accumulated driving time is less than the reference time to be longer than a period for applying the first voltage to the first electrodes when the accumulated driving time exceeds the reference time.

19. The plasma display device of claim 18, wherein the driver is configured to gradually decrease a voltage of the first electrodes during the reset period with a fourth voltage applied to the second electrodes, and to apply a scan pulse to the first electrodes in the address period.

20. The plasma display device of claim 19, wherein the driver is configured to apply the first sustain pulse having an opposite phase to that of the first electrodes and the second electrodes during the first sustain period.
